(19) United States
(12) Patent Application Publication
(10) Pub. No.: US 2005/0126076 A1
(43) Pub. Date: Jun. 16, 2005

(54) System and process for reacting fuel and oxidizer into reformate

(75) Inventor: Stevan Kah, Neubrandenburg (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/989,491

(22) Filed: Nov. 17, 2004

(30) Foreign Application Priority Data
Nov. 27, 2003 (DE) 103 55 494.7

(51) Int. Cl. B01J 8/04

(52) U.S. Cl. 48/198.7; 48/127.9; 422/189; 422/198

(57) ABSTRACT

A system for reacting fuel and oxidizer into reformate employing a reformer having a first reaction zone to which the fuel and oxidizer are supplied, and a second reaction zone to which the product gas emerging from the first reaction zone and an oxidizer are supplied. The reformer further includes on or more heat dissipators for removing reaction heat produced in the first reaction zone before entry of the product gas into the second reaction zone.

### BACKGROUND OF THE INVENTION

1. Field of the Invention

The invention relates to a system for reacting fuel and oxidizer into reformate, employing a reformer which has a first reaction zone, to which the fuel and oxidizer can be supplied, and a second reaction zone to which the product gas, emerging from the first reaction zone, and an oxidizer can be supplied.

2. Description of Related Art

The use of fuel cells in the motor vehicle domain to produce electrical energy is becoming increasingly important. In particular, the continued development of auxiliary power units (APU) is being pursued in order to provide electrical energy to the vehicle electrical system and thereby enable supply of current to the electrical devices located in the motor vehicle so that the supply is independent of the operation of the internal combustion engine.

To produce the electrical energy, SOFC (Solid Oxide Fuel Cell) fuel cells are often used, to which a product gas emerging from the reformer is supplied for purposes of producing electrical energy. Partial oxidation (POX) is often used as the type of reforming performed in the reformer. This process can be carried out thermally (TPOX, Thermal Partial Oxidation) or using a catalyst (CPOX, Catalytic Partial Oxidation). In any situation, in the partial oxidation reaction heat is formed which must be considered in the design of the reformer and other components. Close monitoring of the resulting temperatures is necessary to ensure that the temperatures are below the upper temperature boundaries established for the reformer, components and materials.

One approach to consideration of these upper temperature boundaries is thermal decoupling of the product gas from the reformer after emergence of the product gas from the reformer, as is indicated in, for example, U.S. Pat. No. 6,562,496. In this way, components which are downstream of the reformer can be protected against high temperatures; however, the danger of damage to the catalyst or the reformer materials cannot be completely prevented by this approach.

### SUMMARY OF THE INVENTION

A primary object of the present invention is to develop generic systems and processes such that the problems of the prior art are at least partially overcome and, in particular, the danger of damage to system components is minimized.

The invention is based on a generic system in which there are means for dissipating the reaction heat which has been produced in the first reaction zone before entry of the product gas into the second reaction zone. Generally, the net heat production in the first reaction zone is higher than in the following second reaction zone. It is therefore advisable that the temperature increase which occurs due to the net heat production be limited by dissipating the heat which forms in the first reaction zone. In particular, a gas for further reaction is supplied to the second reaction zone, from which gas the reaction heat from the first reaction zone has been removed so that a further reaction of the gas in the second reaction zone can be easily accomplished with respect to a further temperature increase.

It is particularly useful for the means for dissipating the reaction heat include a heat exchanger for removing heat from the first reaction zone. In this way, the components which are assigned to the first reaction zone can be protected against excess temperatures.

Specifically, this embodiment of the invention would include a means for dissipating the reaction heat utilizing a heat exchanger for removing heat from the product gas which has emerged from the first reaction zone. This measure alone can reduce the temperature load of the components which are downstream of the first reaction zone, i.e., the temperature load of the second reaction zone.

The invention has an advantage in that the means for dissipating the reaction heat can use cathode air of a fuel cell assigned to the system as a cooling medium. In this manner, reaction heat is advantageously dissipated, on the one hand, and on the other hand, the cathode air is heated so that the high temperatures, which are necessary for the operation of a SOFC fuel cell, are reached.

Furthermore, the invention preferably includes a means for dissipating the reaction heat via the use of a cooling medium from a cooling circuit. For example, the cooking circuit of an internal combustion engine. When the system is used in a motor vehicle, the meshing of the system of the invention with other motor vehicle systems can be used.

A particularly advantageous embodiment of the invention occurs when the means for dissipating the reaction heat employs fuel and/or oxidizer as the cooling medium before entry into the reformer. This has the advantage that the substances entering the reformer are preheated and in doing so, at the same time, advantageously dissipates the reaction heat for lowering the temperature.

The system for reacting fuel and an oxidizer of the invention has been developed such that there is an oxidizer supply which has a flow divider to divide the supplied oxidizer between the first and the second reaction zones. The oxidizer, i.e., generally air, can thus be introduced via uniform delivery, division taking place for the different reaction zones by means of a flow divider. The amount of air which is necessary for the reforming processes can thus be centrally set depending on the desired properties of the reformate and depending on the fuel which has been made available.

Additionally, there is a benefit provided by the invention in that there is provided a mixture formation zone to which the oxidizer for the first reaction zone and the fuel can be supplied, while the oxidizer can be supplied directly to the second reaction zone. The mixture formation zone has the advantage, as a result of the division of the supplied oxidizer, i.e., the dwell time of the oxidizer and of the fuel in the mixture formation zone is increased. This promotes the vaporization process of liquid fuels in the mixture formation zone.

Furthermore, the invention relates to a reformer for use in a system of the invention. A reformer, which includes the division of its reaction area into at least two reaction zones and accomplishes the dissipation of the heat which forms in the reaction zone, the aforementioned advantages and particulars of the system of the invention can be implemented.

The invention is based on a generic process in that the reaction heat which has been produced in the first reaction zone is dissipated before entry of the product gas into the second reaction zone. In this way, the advantages of the system of the invention are realized within the framework of the disclosed process. This also applies to the particularly preferred embodiments of the process of the invention which are given below.

The process of the invention is executed in a useful manner such that the reaction heat is dissipated directly from the first reaction zone. Further, in addition to or as an alternative to the general process, the process of the invention can also be provided with the feature that the reaction heat is dissipated from the product gas emerging from the first reaction zone. In this embodiment, it is particularly beneficial that the reaction heat is dissipated by the cathode air of a fuel cell in the system. However, the process can also be carried out such that the reaction heat is dissipated by a cooling medium from the cooling circuit of an internal combustion engine.

Likewise, the invention can be provided with dissipation of reaction heat of the fuel and/or the oxidizer before either enters the reformer.

It is furthermore useful for the supplied oxidizer to be divided between the first and the second reaction zones.

The process of the invention is particularly advantageously in that the oxidizer for the first reaction zone and the fuel are supplied to a mixture formation zone while the oxidizer is directly supplied to the second reaction zone.

In this embodiment, it is particularly beneficial when the amount of oxidizer, which is dictated depending on the desired reforming processes, is used per time, That is, some of the given amount of the oxidizer is supplied depending on the given upper temperature boundaries to the first reaction zone and that the remaining part of the given amount of oxidizer is supplied to the second reaction zone.

The invention is based on the discovery that by dividing the reaction area of the reformer into at least two reaction zones, the danger of exceeding the upper temperature boundaries is reduced by the reaction heat being dissipated from the first reaction zone or being dissipated from the product gas which has emerged from the first reaction zone. The invention is particularly useful in conjunction with reforming processes for providing reformate for a fuel cell.

However, the invention is also suited for numerous other applications in which a product gas from a reformer can be used, for example, in conjunction with motor vehicle exhaust catalytic converters and motor vehicle drives. The invention has been described above as using the process of partial oxidation as the type of reforming, but the invention can also be used for other types of reforming with net heat production.

The invention is now explained by way of example with reference to the accompanying drawings using a preferred embodiment.

### BRIEF DESCRIPTION OF THE DRAWINGS

FIG. 1 is a schematic representation of a system in accordance with the invention, and

FIG. 2 is a flow chart of a process according to the invention.

### DETAILED DESCRIPTION OF THE INVENTION

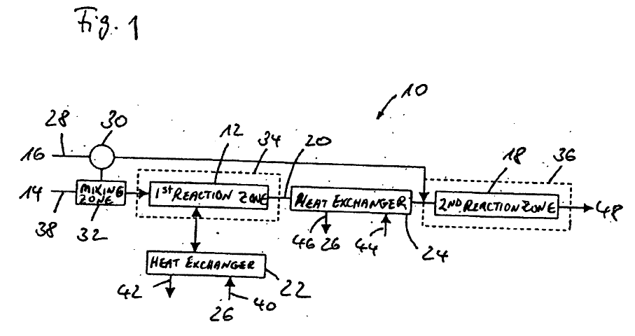

FIG. 1 shows a system in accordance with the invention which has a reformer 10 that includes a first reaction zone 12 and a second reaction zone 18. The reaction zone 12 is surrounded by a housing 34. The reaction zone 18 is surrounded by a housing 36. The first reaction zone 12 is in thermal contact with a heat exchanger 22. Furthermore, between the first reaction zone 12 and the second reaction zone 18, there is a heat exchanger 24. Also provided is an oxidizer supply 10 with a flow divider 30, the part of the oxidizer supply 10 which is downstream of the flow divider discharges into a mixture formation zone 32 and directly into the reaction zone 18. Furthermore, a fuel supply 38 discharges into the mixture formation zone 32. The heat exchanger 22 is equipped with a coolant feed 40 and a coolant return 42. Similarly, the heat exchanger 24 is equipped with a coolant feed 44 and a coolant return 46.

The system as shown in FIG. 1 works as follows. Some of the supplied oxidizer 16 is fed into the mixture formation zone 32 via the oxidizer supply 10 and the flow divider 30. Furthermore, via the fuel supply 38, fuel 14, e.g., gasoline or diesel fuel, is supplied to the mixture formation zone. In the mixture formation zone 32, vaporization and mixing of the oxidizer 16 with the fuel 14 take place. The oxidizer includes, preferably, air which can optionally be mixed with water-containing or water-releasing media flows. It can be, for example, the product gases from combustion processes which have been produced for example in the anode space of the fuel cell and/or in a burner. Likewise, engine exhaust gases can be used. The mixture is then supplied to the first reaction zone 12 where partial exothermal oxidation of the fuel 14 takes place, the reactions being dependent on the amount of oxidizer 16 which has been made available. The reaction heat produced in the reaction zone 12 is partially dissipated via the heat exchanger 22 by means of a coolant 26. The coolant 26, e.g., cathode air, cooling water of the motor vehicle engine or oxidizer or fuel, is supplied via the coolant feed 40 to the heat exchanger 22 and is removed again via the coolant return 42. The product gas emerging from the reaction zone 12 is supplied to another heat exchanger 24. The heat present in the product gas is in turn dissipated via a coolant 26, the coolant being supplied via a coolant feed 44 and being removed via a coolant return 46. It should be noted that the coolants used for heat exchanger 24 can be the same coolants as are used for the heat exchanger 22. The cooled product gas 20 is now supplied to the second reaction zone 18, to which there is supplied the portion of the oxidizer 16 which remains in the flow divider, i.e., that amount which has not be supplied to the mixture formation zone 32. In the second reaction zone 18, a further reaction of the product gas 20 with the oxidizer 16 takes place, with the reaction again corresponding to the remaining amount of oxidizer 16. The finished reformate can then be removed from the second reaction zone 18 and can be supplied to another application, e.g., a fuel cell.

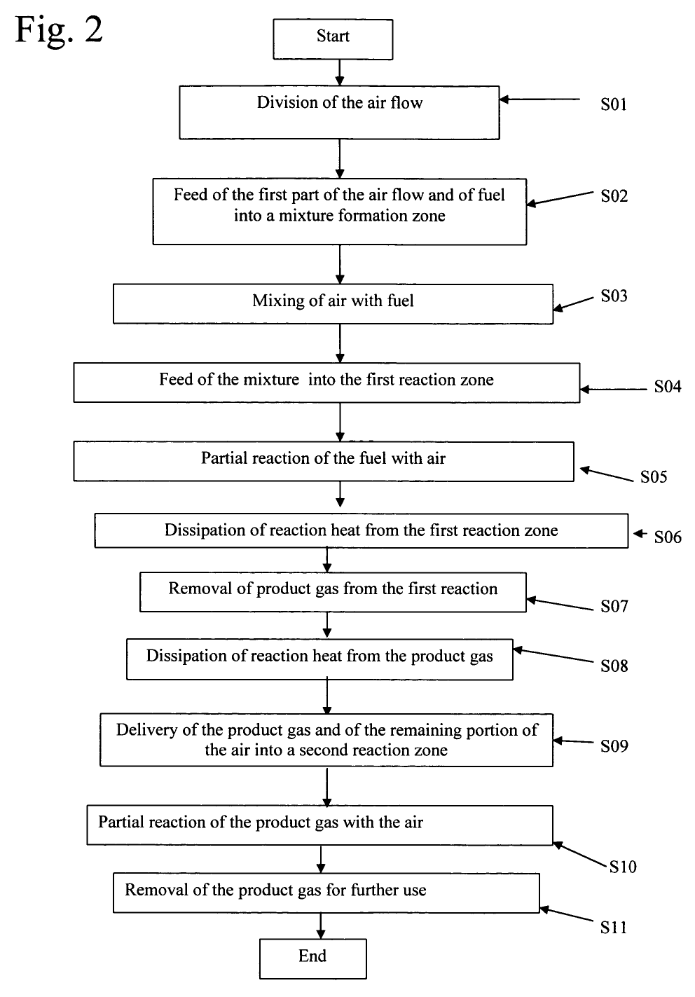

FIG. 2 shows a flow chart of the process of the invention. In step S01, an air flow is divided by a flow divider into a first part and a second part. In step S02, the first part of the air flow is supplied to the mixture formation zone. This mixture formation zone is likewise supplied with the fuel which is to be oxidized. The fuel, generally supplied in liquid form, vaporizes in the mixture formation zone and is mixed with air in step S03. The mixture is supplied in step S04 to the first reaction zone in which, according to step S05, partial reaction of the fuel with the air takes place. In step S06, the reaction heat which has been produced in the first reaction zone is partially dissipated by a heat exchanger. In step S07, the product gas is removed from the first reaction zone, and, in step S08, additional reaction heat is removed from the product gas. In step S09, the product gas and the remaining second part of the air emerging from the flow divider are supplied to a second reaction zone. Here, according to step S10, further partial reaction of the product gas with air takes place. In step S11, the product gas is removed from the second reaction zone.

The foregoing specific embodiment of the apparatus, processes, and/or compounds employed in the practice of the present invention are, of course, intended to be illustrative rather than limiting, and it will be apparent that numerous variations and modifications of these specific embodiments may be practiced within the scope of the appended claims.

1. A system for reacting fuel and oxidizer into reformate employing a reformer comprising:
a first reaction zone into which the fuel and oxidizer are supplied;
a second reaction zone into which product gas emerging from the first reaction zone and an oxidizer are supplied; and
means for dissipation of reaction heat of the product gas produced in the first reaction zone before entry of the product gas into the second reaction zone, said means for dissipation being connected to the first reaction zone or a location between the first reaction zone and second reaction zone.

2. The system of claim 1, wherein the means for dissipating the reaction heat comprises a heat exchanger connected to the first reaction zone for dissipating heat from the first reaction zone.

3. The system of claim 1, wherein the means for dissipating the reaction heat comprises a heat exchanger located between the first and second reaction zones for dissipating heat from the product gas emerging from the first reaction zone.

4. The system of claim 1, wherein the means for dissipating the reaction heat employs cathode air from a fuel cell as a cooling medium.

5. The system of claim 1, wherein the means for dissipating the reaction heat can employs a cooling medium from a cooling circuit of an internal combustion engine.

6. The system of claim 1, wherein the means for dissipating the reaction heat employs, as a cooling medium, at least one of the fuel and the oxidizer prior to the entry of the fuel and oxidizer into the reformer.

7. The system of claim 1, further comprising an oxidizer supply and a flow divider to divide the supplied oxidizer between the first reaction zone and to the second reaction zone.

8. The system of claim 1, further comprising:
a mixture formation zone into which the oxidizer and the fuel for the first reaction zone are supplied; and
a means for supplying oxidizer directly to the second reaction zone.

9. A reformer comprising:
a first reaction zone into which the fuel and oxidizer are supplied;
a second reaction zone into which product gas emerging from the first reaction zone and an oxidizer are supplied; and
means for dissipation of reaction heat of the product gas produced in the first reaction zone before entry of the product gas into the second reaction zone, said means for dissipation being connected to the first reaction zone or a location between the first reaction zone and second reaction zone.

10. A process for reacting fuel and oxidizer into reformate employing a reformer comprising:
a first reaction zone into which the fuel and oxidizer are supplied;
a second reaction zone into which product gas emerging from the first reaction zone and an oxidizer are supplied; and
means for dissipation of the reaction heat of the product gas produced in the first reaction zone before entry of the product gas into the second reaction zone, said means for dissipation being connected to the first reaction zone or a location between the first reaction zone and second reaction zone;
the method comprising the step employing the dissipation means to dissipate the reaction heat produced in the first reaction zone before entry of the product gas into the second reaction zone.

11. The process of claim 10, wherein the dissipating of the reaction heat is performed by the dissipation means in the first reaction zone.

12. The process of claim 10, wherein the dissipating of the reaction heat is performed by the dissipation means between the first and second reaction zones.

13. The process of claim 10, wherein cathode air of a fuel cell is used for dissipating the reaction heat.

14. The process of claim 10, wherein a cooling medium from a cooling circuit of an internal combustion engine is used for dissipating the reaction heat.

15. The process of claim 10, wherein at least one of fuel and the oxidizer is used for dissipating the reaction heat prior to entry of the at least one of the fuel and the oxidizer into the reformer.

16. The process of claim 10, further comprising the steps of:
providing a source of oxidizer; and
dividing the oxidizer between the first and the second reaction zones.

17. The process of claim 10, further comprising the steps of:
supplying the oxidizer and fuel to a mixture formation zone upstream of the first reaction zone; and
supplying oxidizer directly to the second reaction zone.

18. The process of claim 17, wherein the amount of oxidizer required by the first reaction zone is dependent on a desired reforming process and is used per time such that some of a given amount of the oxidizer is supplied depending on an upper temperature boundary of the first reaction zone and the remaining portion of the given amount of oxidizer is supplied to the second reaction zone.
